(19) United States
(12) Patent Application Publication
(10) Pub. No.: US 2019/0333036 A1
(43) Pub. Date: Oct. 31, 2019

(54) NETWORKED VENDING MACHINE WITH DRONE BASED DELIVERY AND AUGMENTED REALITY VIEWING SYSTEMS

(71) Applicant: Carolyn Bryant, Pasadena, CA (US)

(72) Inventor: Carolyn Bryant, Pasadena, CA (US)

(21) Appl. No.: 15/912,316

(22) Filed: Mar. 5, 2018

(51) Int. Cl. G06Q 20/18; H04W 4/35; G06Q 20/20; G06Q 10/08; G06Q 30/06

(52) U.S. Cl. CPC G06Q 20/18; H04W 4/35; G06Q 20/202; H04L 67/12; G06Q 30/0643; G06Q 20/203; G06Q 20/206; G06Q 10/083

(57) ABSTRACT

A vending machine having a controller and a network server coupled to the controller and to a user via a wide area network; and a user device adapted to communicate with the controller via the server to view and select product from vending machine. In one embodiment, the system includes an arrangement for automatically dispensing product to a drone for delivery. A virtual vending machine embodiment provides a display of a virtual vending machine to a user with products located in multiple diverse locations. The system includes an augmented reality system that enables a user to view product in inventory in the vending machine or in a virtual vending machine representing inventory not stored in a single physical machine. Voice activation functionality is enabled at the physical vending machine and via a user's smartphone. The system is adapted to provide detailed information, via a user's smartphone or an onsite display integrated into the vending machine, regarding how the selection might affect the user/patient, how it should be used and/or how it has been rated by other users/patients. In a particularly unique embodiment, the inventive system includes an application adapted to run on a user's smartphone that provides access for the vision impaired through voice activation, checks the user's biometric data and/or confirms the user's identity. The inventive vending machine includes an arrangement for dispensing a scent or aroma of selected products.

### BACKGROUND OF THE INVENTION

### Field of the Invention

The present invention relates to electrical and mechanical systems. More specifically, the present invention relates to vending machines.

### Description of the Related Art

Vending machines are well-known in the art. As noted by Wikipedia: “A vending machine is an automated machine that provides items such as snacks, beverages, alcohol, cigarettes and lottery tickets to consumers after money or a credit card is inserted into the machine. The first modern vending machines were developed in England in the early 1880s that dispensed postcards. Vending machines exist in many countries, and in more recent times, specialized vending machines that provide less common products compared to traditional vending machine items have been created and provided to consumers.” https://en.wikipedia.org/wiki/Vending_machine. Accordingly, conventional vending machines require the user to be physically present at the machine to select, pay for and receive product. For some users, this requirement imposes a significant restraint or inconvenience on the user.

Hence, for such users, there is a need in the art for an intelligent vending machine that does not require the user to be physically present to select, pay for or receive products purchased from the machine.

### SUMMARY OF THE INVENTION

The need in the art is addressed by the system of the present invention. In the illustrative embodiment, the inventive system includes a vending machine having a controller and a network server coupled to the controller and to a user via a wide area network; and a user device adapted to communicate with the controller via the server to view and select product from vending machine.

In one embodiment, the system includes an arrangement for automatically dispensing product to a drone for delivery. A virtual vending machine embodiment provides a display of a virtual vending machine to a user with products located in multiple diverse locations.

The system includes an augmented reality system that enables a user to view product in inventory in the vending machine or in a virtual vending machine representing inventory not stored in a single physical machine. Voice activation functionality is enabled at the physical vending machine and via a user's smartphone. The system is adapted to provide detailed information, via a user's smartphone or an onsite display integrated into the vending machine, regarding how the selection might affect the user/patient, how it should be used and/or how it has been rated by other users/patients.

In a particularly unique embodiment, the inventive system includes an application adapted to run on a user's smartphone that provides access for the vision impaired through voice activation, checks the user's biometric data and/or confirms the user's identity. The inventive vending machine includes an arrangement for dispensing a scent or aroma of selected products.

### BRIEF DESCRIPTION OF THE DRAWINGS

FIG. 1 is a perspective view of an illustrative embodiment of a vending machine system in accordance with the present teachings.

FIG. 2 is a frontal view of the vending machine depicted in FIG. 1.

FIG. 3 is a side view of the vending machine of FIG. 1.

FIG. 4 is a top view of the vending machine of FIG. 1.

FIG. 5 is a bottom view of the vending machine of FIG. 1.

FIG. 6 is a block diagram of an illustrative embodiment of electronic circuitry of a network provided by the vending machine of the present teachings.

FIGS. 7(a-c) are a flow diagram of an illustrative embodiment of an operational method of a vending machine network implemented in accordance with the present teachings.

FIGS. 8(a-b) are a flow diagram of an illustrative embodiment of an operational method of a user's device in a network implemented in accordance with the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

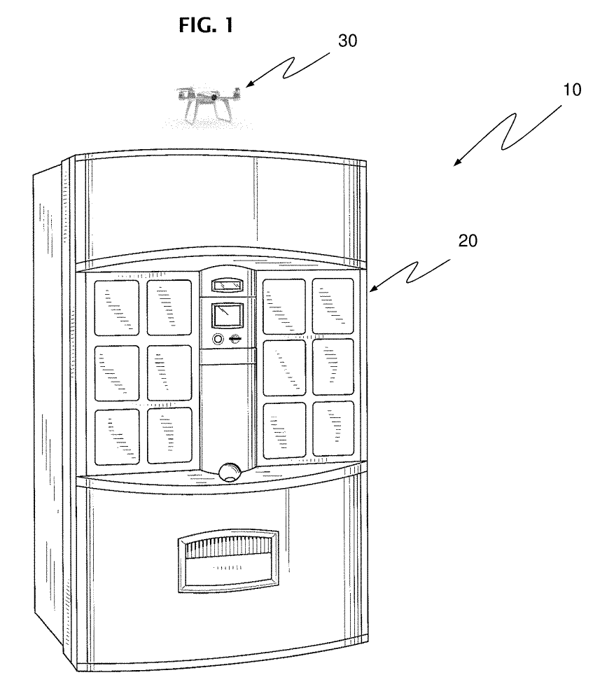

FIG. 1 is a perspective view of an illustrative embodiment of a vending machine system in accordance with the present teachings.

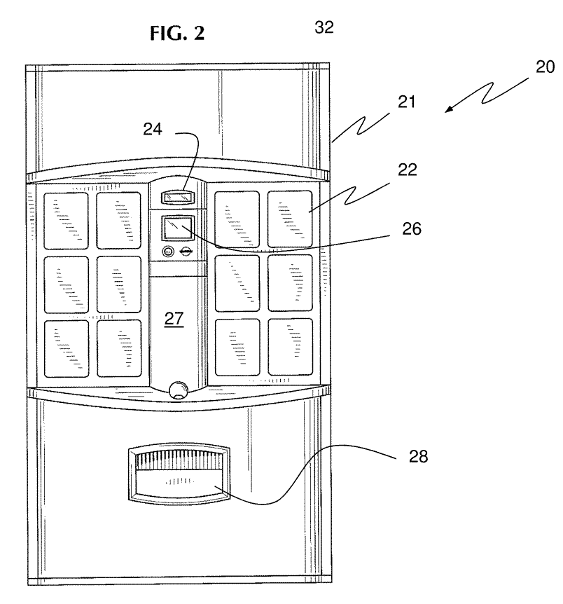

FIG. 2 is a frontal view of the vending machine depicted in FIG. 1.

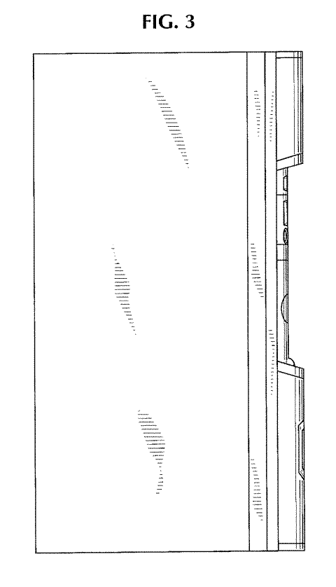

FIG. 3 is a side view of the vending machine of FIG. 1.

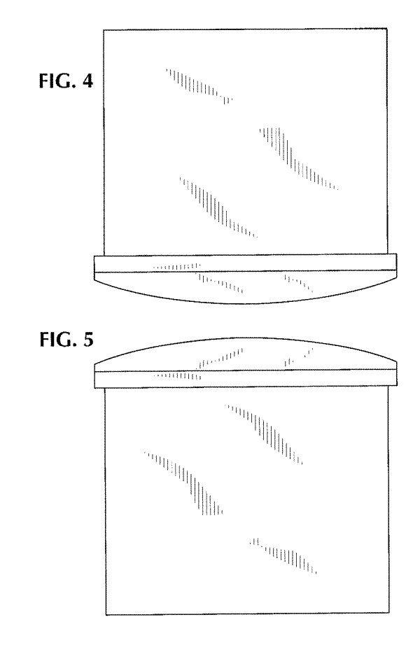

FIG. 4 is a top view of the vending machine of FIG. 1.

FIG. 5 is a bottom view of the vending machine of FIG. 1.

As shown in FIGS. 1-5, the system 10 includes a novel vending machine 20 and a drone 30. The vending machine 20 includes a housing 21 and plural physical and/or virtual windows 22 (of which 12 are shown in the drawings for the purpose of illustration) for displaying products available for purchase via the machine 20. Conventionally, each physical window 22 is a simple transparent glass or plastic window. In accordance with the present teachings, one or more of the windows is a digital display of products available in the machine and hence ‘virtual’.

As shown in FIG. 2, a reader 24 is provided for accepting currency of all currently known types including cash, credit and debit cards and crypto (aka ‘digital’) currency. A user display 26 is also mounted on the control panel 27 of the machine 20.

In accordance with the present teachings, the vending machine is an integral component in a network including one or more vending machines, warehouses, retailers' databases and plural customer devices. This is disclosed more fully below.

### Electronics:

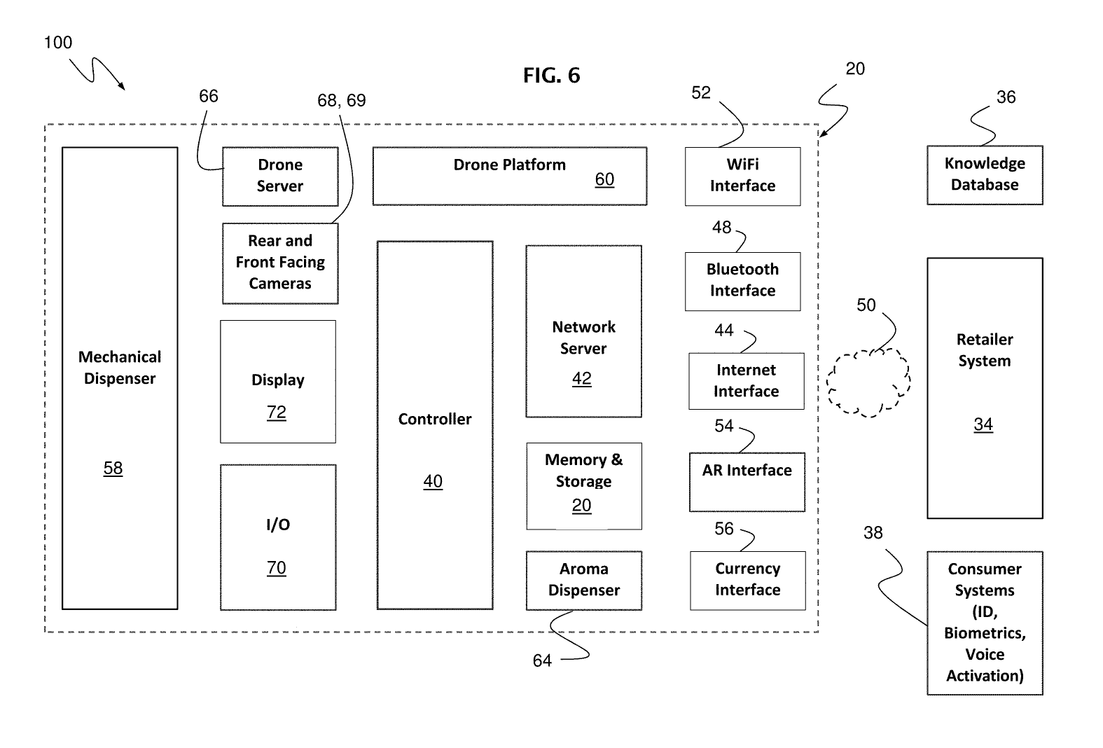

FIG. 6 is a block diagram of an illustrative embodiment of electronic circuitry of a vending network provided by the present teachings. Bus lines showing electrical and operational connections between elements are omitted for simplicity and clarity. However, those of ordinary skill in the art will appreciate that electrical and operational connections would be required for proper operation in accordance with the teachings below.

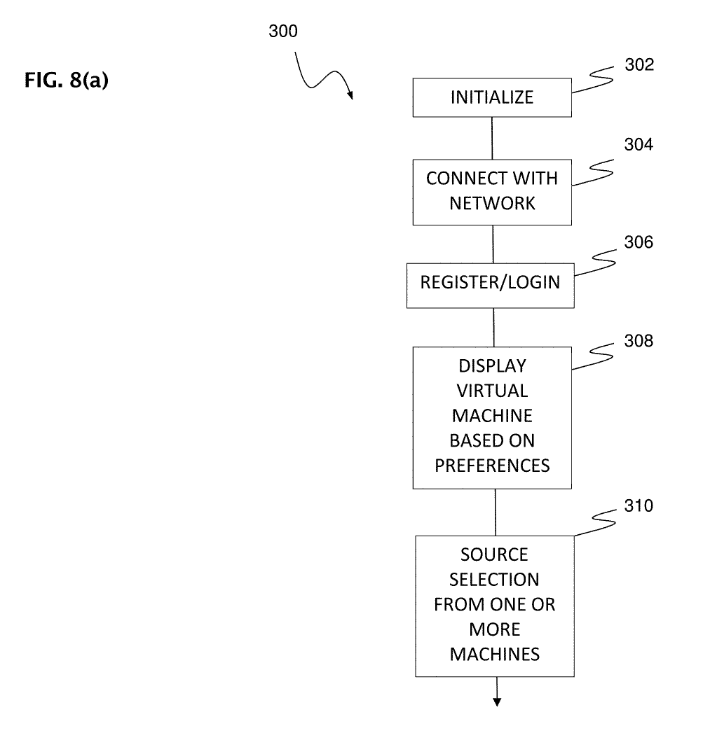

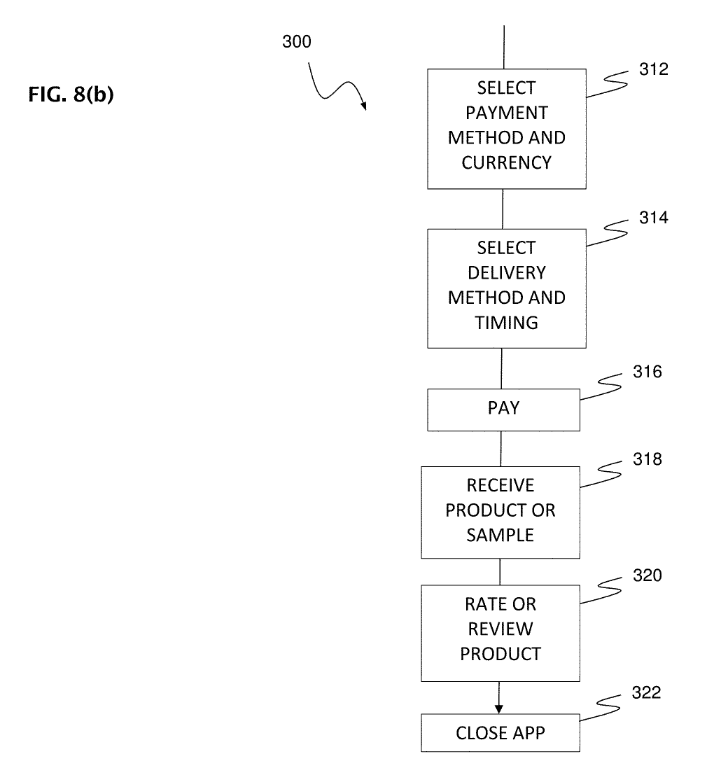

As shown in FIG. 6, the vending network 100 includes a vending machine 20 which is operationally connected to a retailer's system 34 and a database 36 via a wide area network such as the World Wide Web 50. Consumer systems (also referred to as ‘user’ systems herein) 38, ideally implemented with smartphones, are included in the network 100 and connected to the vending machine system 20 via a cellular data network, Internet, World Wide Web, local area network or a wide area network all shown generally at 50. Operation of an illustrative embodiment of a user system is discussed more fully below with respect to FIG. 8.

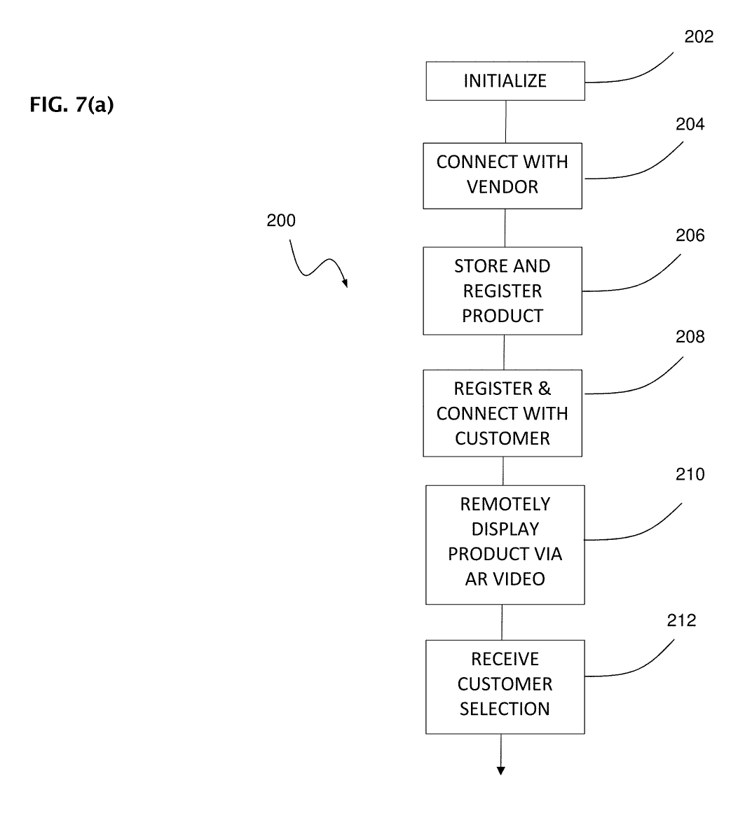

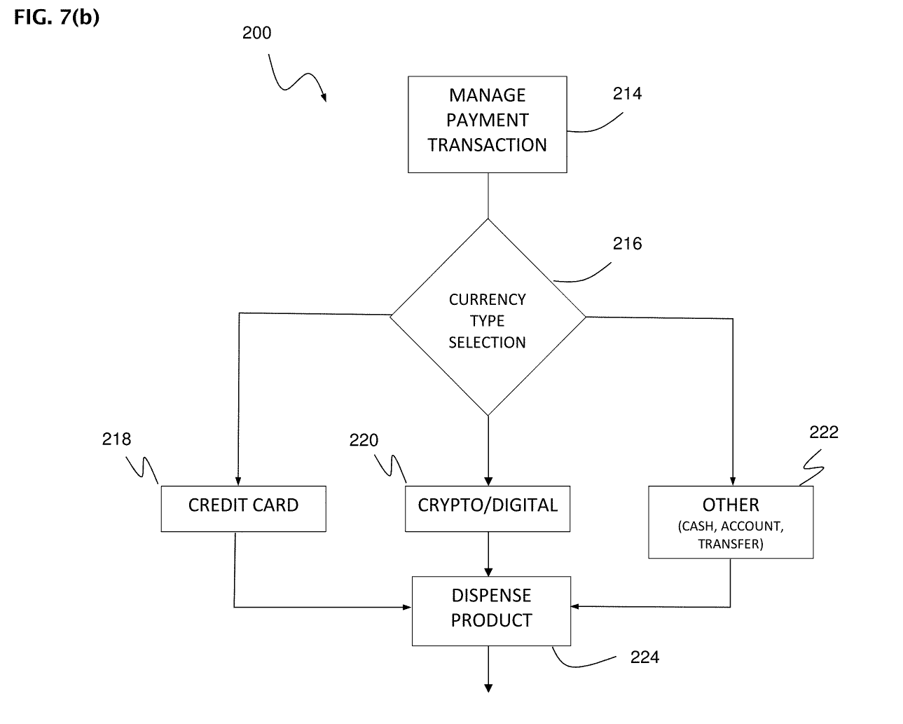

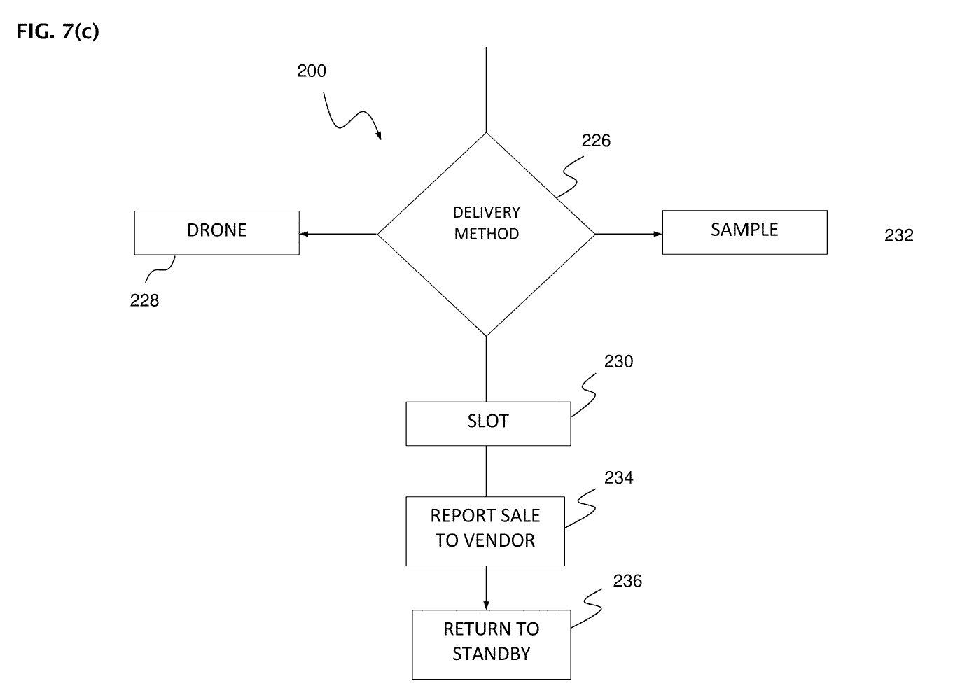

At the core of the vending machine system 20 is a controller 40 implemented, in the best mode, with a microprocessor or group of processors. The controller executes a program stored a tangible mechanical or electronic storage medium 62. The methodology of the present invention provided by the program is described more fully below with respect to the flow charts of FIGS. 7 and 8.

The controller 40 communicates with the retailer system 34, database 36 and user systems 38 via a network 50 such as the World Wide Web or Internet, internet interface 44, Bluetooth interface 48 and/or WIFI interface 52 and a network server 42. The network server 42 provides bidirectional communications protocols needed for the interfaces 44, 48 and 52 to communicate with the controller 40.

Onsite maintenance personnel inputs are provided to the controller 40 by a conventional input/output (I/O) interface 70 such as a keyboard and pointing device. A setup display 72 is provided for onsite use by maintenance personnel as well. Rear and front facing cameras 68, 69 are included. The rear facing camera 68 is included and coupled to the controller for capturing images of the products stored in the vending machine 20 or symbols associated therewith for use with the augmented reality interface 54 and subsystem disclosed more fully below. The front facing camera 69 is included for identity confirmation.

On receipt of payment using currency onsite, or remote activation via a currency interface 56, the controller activates a mechanical dispenser 58 to dispense product in a conventional manner.

In accordance with the present teachings, an alternative product delivery modality is provided via the drone depicted in FIG. 1, a drone platform 60, and a drone server 66 (see FIG. 6).

The operation of the invention is discussed more fully below.

### Operation:

Onsite Mode:

In an onsite mode of operation, a machine 20 is installed at a designated location and set up by an onsite technician. During this initial set up, the system 20 is powered up and the controller 40 is initialized by reading bios information from onsite physical and electronic storage as is common in a conventional computer. Next, a vendor, retailer or technician fills the machine with product and the machine is set for normal operation.

Then, when a purchase is desired, a consumer inserts a credit card into the card reader slot 24 on the machine 20 to initiate a transaction in a conventional manner (See FIG. 2.)

As an alternative enabled by the present teachings, the consumer uses a smart phone or other digital storage and retrieval device to initiate a transaction using digital (aka ‘crypto’) currency. These signals are processed by a crypto-currency interface 56 in a conventional manner via the internet interface 44 and network 50 as necessary or desired. See, for example, U.S. Pat. No. 9,836,790 entitled Cryptocurrency Transformation System, issued Dec. 5, 2017, the teachings of which are hereby incorporated herein by reference along with any and all patents and applications referenced therein.

In this case, the controller 40 (FIG. 2) causes the machine 20 to dispense product via the mechanical dispenser 58 (or samples via the aroma dispenser 64) in response to signals from the consumer's smartphone 38 via a Bluetooth interface 48 or a WIFI interface 52.

The present invention is not limited to any particular crypto-currency or block chain based digital currency. In any case, it should be apparent to those of ordinary skill in the art that the present invention is currency agnostic.

The virtual vending machine mode of operation is discussed more fully below.

Virtual Mode:

FIGS. 7(a-c) are a flow diagram of an illustrative embodiment of an operational method of a virtual vending machine network implemented in accordance with the present teachings. At step 202, the system 10 is initialized.

In the virtual vending machine implementation, a vendor connects to the system 10 and registers product information as being available for purchase from vending machines implemented in accordance with the present teachings or a warehouse. These steps are shown generally at 204 and 206 in FIGS. 7(a-c). At step 208, a consumer registers for virtual access to the system.

At step 210, the user views the content of a virtual vending machine via an AR interface 54. The AR (augmented reality) interface 54 receives imagery and symbols associated with various products from the retailer system 34 along with data relating thereto from the knowledge database 36 and formats the imagery and data for presentation to the user based on the user's platform and preferences. For example, the AR interface 54 may take actual video or images of a selection and send it to the user for viewing. This may be effected via the rear facing cameras 68 shown in FIG. 6 in the case where the virtual machine is based on the contents of one or more physical vending machines or via standalone cameras or computer imagery when a physical vending machine is not the source of the imagery.

As an alternative, the AR interface may receive images, symbols, bar codes, QR codes or video from the retailer system 34 and present the associated images and data to the consumer for review and consideration prior to making a selection.

In any case, it should be clear that in accordance with the present teachings, the virtual vending machine can display products in inventory from multiple vendors' and inventories whether disposed in a physical vending machine or not.

At step 212, the consumer makes a selection and at step 214, the system 10 processes the payment transaction by initially prompting the user or consumer to select currency type. At step 216, the consumer's currency type selection is received and used to process the transaction in the manner discussed more fully above with respect to onsite, physical vending machine operational mode.

After payment, at step 226, the selected product is dispensed for pickup or delivery. If drone delivery is selected, in accordance with the present teachings, at step 228, a drone 30 (FIG. 1) acquires at the drone delivery platform 60 and delivers the package. This option is likely to be particularly useful for short haul urban trips (e.g., apartment complexes, college campuses etc.) and long haul rural deliveries.

If at step 226, ‘pickup’ is selected, then at step 220, the selected product is dispensed to the consumer via the slot 28 (FIG. 2).

If at step 212, the user selects ‘free sample’, then at step 226 the system outputs a sample (such as an aroma using the aroma dispenser 64 of FIG. 6), then at step 232, a sample is output. Aromas may be stored in the machine 20 via electronically actuated spray cannisters (not shown).

At step 234, sales are optionally credited and/or reported to the vendor (retailer 34) of the product via the controller 40, network server 42, internet interface 44 and network 50 for inventory control, marketing purposes and/or other purposes.

At step 236, the system returns to standby mode.

### Consumer Platform:

In the best mode, the consumer platform is implemented with an iPhone, Android or other comparable smartphone. Other computing and communications platforms may be used without departing from the scope of the present teachings.

FIGS. 8(a-b) are a flow diagram of an illustrative embodiment of an operational method of a user's device in a network implemented in accordance with the present teachings. As shown in FIGS. 8(a-b), the method 300 includes a first initializing step. This would typically involve downloading and launching a program or application (aka ‘app’) designed to communicate within the network 100 of FIG. 6.

At step 304, the app connects with the network 100 and at step 306, the user either registers or logs in if already registered.

At step 308, the user selects desired product types and is presented by the app with a display of a virtual vending machine in which plural units of the desired product type(s) from various vendors is/are displayed on the user's smartphone. In the best mode, movement of the user's smartphone changes the display of products as if the smartphone is a window into the virtual vending machine. This may be effected using gyros, accelerometers, GPS and other location and orientation sensors commonly provided in conventional smartphones.

Those skilled in the art will appreciate that, as an alternative, each vending machine may be dedicated to display products from a single vendor or retailer and that a virtual headset may also be used to view the contents of the virtual vending machines without departing from the scope of the present teachings.

In any case, at step 310, the user selects products for purchase and delivery and at step 312, payment method and currency are selected. As noted above, the user's identification (ID) may be confirmed automatically via biometric sensors in the smartphone such as the fingerprint or face sensors of the iPhone or manually via video conference with a retailer.

At step 314, the delivery method and timing are selected and at step 316, payment is effectuated. The user receives the product, or perhaps a sample, at step 318 and at step 320, the user is invited to rate or review the product.

Thus, in the illustrative embodiment, the inventive system provides a vending machine having a controller and a network server coupled to the controller and to a user via a wide area network; and a user device adapted to communicate with the controller via the server to view and select product from vending machine. In one embodiment, the system includes an arrangement for automatically dispensing product to a drone for delivery. A virtual vending machine embodiment provides a display of a virtual vending machine to a user with products located in multiple diverse locations. The system includes an augmented reality system that enables a user to view product in inventory in the vending machine or in a virtual vending machine representing inventory not stored in a single physical machine. Voice activation functionality is enabled at the physical vending machine and via a user's smartphone. The system is adapted to provide detailed information, via a user's smartphone or an onsite display integrated into the vending machine, regarding how the selection might affect the user/patient, how it should be used and/or how it has been rated by other users/patients. In a particularly unique embodiment, the inventive system includes an application adapted to run on a user's smartphone that provides access for the vision impaired through voice activation, checks the user's biometric data and/or confirms the user's identity. The inventive vending machine includes an arrangement for dispensing a scent or aroma of selected products.

Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A system comprising:
a vending machine having:
a controller and
a network server coupled to the controller and to a user via a wide area network; and
a user device adapted to communicate with the controller via the server to view and select product from vending machine.

2. The invention of claim 1 wherein the vending machine further includes a system for voice activation functionality.

3. The invention of claim 1 wherein the vending machine includes an augmented reality system.

4. The invention of claim 1 wherein the vending machine includes a system for dispensing a scent or aroma of selected products.

5. The invention of claim 1 wherein the vending machine includes a system for automatically dispensing product to a drone.

6. The invention of claim 1 wherein the machine dispenses knowledge via the smartphone, regarding how the selection might affect the user/patient, how it should be used and how it has been rated by other users/patients.

7. The invention of claim 1 wherein the system includes an arrangement for checking a user's ID.

8. The invention of claim 1 wherein the system includes an arrangement for checking a user's biometric data.

9. The invention of claim 1 wherein the user device executes an app that provides access for the vision impaired through voice activation.

10. A virtual vending machine for storing and transmitting images of products in inventory to a user including:
a controller including a processor;
memory fixed in a tangible medium for execution by said controller to output a display of a virtual vending machine to a user showing products located in plural separate locations; and
a network server operationally coupled to the controller and to a user device via a wide area network.

11. The invention of claim 10 a user device adapted to communicate with the controller via the network server to view and select product from vending machine.

12. A vending machine comprising:
a housing;
a controller mounted within said housing;
a network server operationally coupled to the controller and to a user via a wide area network; and
a system mounted within the housing for automatically dispensing product to a drone and
a smartphone physically independent from said housing adapted to communicate with the controller via the server to view and select product for delivery by the drone from the vending machine.
